(19) United States
(12) Patent Application Publication
(10) Pub. No.: US 2007/0082146 A1
(43) Pub. Date: Apr. 12, 2007

(54) Inkjet recording element

(76) Inventors: Gerard A. Friour, Chalon-Sur-Sadne (FR); Jerome Emonot, Chalon-Sur-Saone (FR); Olivier J. Poncelet, Chalon-Sur-Saone (FR); Bruce C. Campbell, Webster, NY (US); Thomas M. Laney, Spencerport, NY (US)

Correspondence Address: PATENT LEGAL STAFF, EASTMAN KODAK COMPANY, 343 STATE STREET, ROCHESTER, NY, 14650-2201, US

(21) Appl. No.: 10/578,810

(22) PCT Filed: Oct. 21, 2004
(86) PCT No.: PCT/EP04/11896

§ 371 Date: May 4, 2006

(30) Foreign Application Priority Data
Nov. 5, 2003 (FR) 0312953

(51) Int. Cl. B41M 5/50

(52) U.S. Cl. 428/32.34

(57) ABSTRACT

The present invention relates to an inkjet recording element having good dye keeping properties in time, good image quality, as well as instant dryness. Said inkjet recording element comprises a porous polyester support and at least one ink-receiving layer, said ink-receiving layer comprising at least one aluminosilicate polymer obtainable by a preparation method consisting in treating an aluminum halide with a mixture of at least one silicon alkoxide only having hydrolyzable substituents and at least one silicon alkoxide having a non-hydrolyzable substituent, with an aqueous alkali in the presence of silanol groups, the aluminum concentration being maintained less than 0.3 mol/l, the Al/Si molar ratio being maintained between 1 and 3.6 and the alkali/Al molar ratio being maintained between 2.3 and 3; and then stirring the resulting mixture at ambient temperature in the presence of silanol groups for long enough to form the hybrid aluminosilicate polymer. In addition, the ink-receiving layer does not contain a binder.

### FIELD OF THE INVENTION

The present invention relates to an inkjet recording element.

### BACKGROUND OF THE INVENTION

Digital photography has been growing fast for several years and the general public now has access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the inkjet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of them. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the base of inkjet printers used in office automation. With this method, the pressure in the ink cartridge is not maintained constant but is applied when a character has to be formed. In one widespread system there is a row of 12 open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps in the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of obtained image. The printing paper must combine the following properties: high quality printed image, rapid drying after printing, good dye keeping in time, smooth appearance, and high gloss. However, given the wide range of ink compositions (pigment based or dye based), and the volume of ink that the printing paper has to absorb, it is very difficult to obtain all these required properties at the same time.

In general, the printing paper comprises a support coated with one or more layers according to the properties required. It is possible, for example, to apply on a support a primary attachment layer, an absorbent layer, an ink-fixing layer and a protective layer or surface layer to provide the glossiness of the inkjet recording element. The absorbent layer absorbs the liquid part of the water-based ink composition after creation of the image. Elimination of the liquid reduces the risk of ink migration to the surface. The ink fixing layer prevents any ink loss into the fibers of the paper base to obtain good color saturation while preventing excess ink that would encourage the increase in size of the printing dots and reduce the image quality. The absorbent layer and fixing layer can also constitute a single ink-receiving layer ensuring both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe inkjet recording elements in which the ink-receiving layer contains as inorganic receivers Ludox™ CL (colloidal silica) marketed by Grace Corporation or Dispal™ (colloidal boehmite) marketed by Sasol. European Patent Application EP-A-1,184,193 describes an inkjet recording element comprising an ink-permeable polyester substrate, and a porous ink-receiving layer comprising a binder, such as a hydrophilic polymer (polyvinyl alcohol or gelatin) and the inorganic receivers mentioned above.

However, printing paper comprising an ink-receiving layer containing such inorganic receivers can have poor image stability in time, which is demonstrated by a loss of color density. The ink-receiving layer can also reduce the porous support's absorbent capacity.

To meet the new requirements of the market in terms of photographic quality, printing speed and color stability, it is necessary to offer a new inkjet recording element having the properties as defined above, more particularly good image quality shown by high optical density, good dye keeping properties in time, while keeping instant dryness.

### SUMMARY OF THE INVENTION

The new inkjet recording element according to the present invention comprises a support and at least one ink receiving layer, and is characterized

in that said support comprises a base polyester layer and a porous ink-permeable upper polyester layer, said upper polyester layer comprising a continuous polyester phase having an ink absorbency rate resulting in a dry time of less than 10 seconds and a total absorbent capacity of at least 14 cm³/m²,

in that said ink-receiving layer does not comprise a binder, and in that said ink-receiving layer comprises at least one hybrid aluminosilicate polymer obtainable by a preparation method comprising the following steps:
a) treating a mixed aluminum and silicon alkoxide of which the silicon has both hydrolyzable substituents and a non-hydrolyzable substituent, or a mixed aluminum and silicon precursor resulting from the hydrolysis of a mixture of aluminum compounds and silicon compounds only having hydrolyzable substituents and silicon compounds having a non-hydrolyzable substituent, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;
b) stirring the mixture resulting from step a) at ambient temperature in the presence of silanol groups long enough to form the hybrid aluminosilicate polymer; and
c) eliminating the byproducts formed during steps a) and b) from the reaction medium.

Throughout the present description, the expression “non-hydrolyzable substituent” means a substituent that does not separate from the silicon atom during the process and in particular at the time of treatment with the aqueous alkali. Such substituents are for example hydrogen, fluoride or an organic group. On the contrary, the expression “hydrolyzable substituent” means a substituent eliminated by hydrolysis in the same conditions.

In the following, the expression “modified mixed aluminum and silicon alkoxide” means a mixed aluminum and silicon alkoxide in which the aluminum atom only has hydrolyzable substituents and the silicon atom has both hydrolyzable substituents and a non-hydrolyzable substituent.

Similarly, the expression “modified mixed aluminum and silicon precursor” means a precursor obtained by hydrolysis of a mixture of aluminum compounds and silicon compounds only having hydrolyzable substituents and silicon compounds having a non-hydrolyzable substituent. This is the non-hydrolyzable substituent that will be found again in the hybrid aluminosilicate polymer used in the present invention.

More generally, an “unmodified” compound is a compound that only consists of hydrolyzable substituents and a “modified” compound is a compound that consists of a non-hydrolyzable substituent.

The inkjet recording element according to the present invention has improved image quality and dye keeping in time compared with the inkjet printing materials available on the market, as well as instant dryness, whatever the type of ink used.

### BRIEF DESCRIPTION OF THE DRAWINGS

FIG. 1 represents the percentage of color density loss for various comparative inkjet recording elements and according to the present invention when exposed to ozone, and

FIGS. 2 and 3 represent the drop volume as a function of the time to measure the instant dryness of the inkjet recording elements according to the invention.

### DETAILED DESCRIPTION OF THE INVENTION

The inkjet recording element according to the present invention comprises firstly a support. This support comprises a base polyester layer and a porous ink-permeable upper polyester layer. Such a support is described in European Patent Application EP-A-1,112,858. The support used in the present invention may be made on readily available polyester film formation machines. The support is preferably made in one step, the base polyester layer and the ink-permeable upper polyester layer being co-extruded, stretched and integrally connected during formation. The one-step formation process leads to low manufacturing costs. The support used in the invention has rapid ink absorption as well as a high absorbent capacity, which allows rapid printing and short dry time. The support used in the present invention has the look and feel of paper, which is desirable to the consumer, is resistant to humidity and has high resistance to tearing and deformation.

The base polyester layer provides stiffness to the support used in the invention as well as the physical integrity to the co-extruded porous permeable upper layer.

The base polyester layer is substantially impermeable. In a preferred embodiment, the base polyester layer is comprised of poly(ethylene terephthalate) and its copolymers.

The thickness of the base layer is selected so that the total support thickness is between 50 μm and 500 μm depending on the required stiffness of the material. However, the thickness of the upper polyester layer is adjusted to the total absorbent capacity of the inkjet recording element. A thickness of at least 28.0 μm is needed to achieve a total absorbency of 14 cm³/m².

The ink-permeable upper polyester layer preferably contains voids that are interconnected or open-celled. This type of structure improves ink absorption rate by enabling capillarity action to occur. The upper polyester layer comprises a matrix or continuous phase of polyester having an ink absorbency rate resulting in a dry time of less than 10 seconds. Dry time is measured by printing a color line on the side of the upper layer with an inkjet printer HP 722 using a standard HP dye-based ink cartridge (HP # C1823 A), at a laydown of 14 cm³/m² approximately.

Dry time is measured by superposing a fresh printing paper on top of the printed line pattern immediately after printing and pressing the papers together with a roller press. If a particular printed line transfers to the surface of the fresh paper, its transferred length L could be used for estimating the dry time t_{D} using a known linear transport speed S of the printer based on the formula

$${t}_{D} = \frac{L}{S}$$

In a preferred embodiment, the ink absorbency rate results in a measured dry time of less than 1 second.

The thickness of the upper polyester layer should be such as to enable at least 14.0 cm³ of ink to be absorbed per 1 m². The actual thickness can be determined by using the formula t=14.0/v where v is the void volume fraction defined as the ratio of the voided thickness minus unvoided thickness to the voided thickness. The unvoided thickness is defined as the thickness that would be expected had no voiding occurred.

The polyester used in the upper layer should have a glass transition temperature between 50° C. and 150° C., preferably between 60° C. and 100° C., should be stretchable and have an inherent viscosity of at least 0.5 dl/g, preferably between 0.6 and 0.9 dl/g. Suitable polyesters include those produced from aromatic, aliphatic, or cycloaliphatic dicarboxylic acids, of 4-20 carbon atoms and aliphatic or alicyclic glycols having from 2-24 carbon atoms.

Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexane-dicarboxylic acids, sodiosulfo isophthalic acids, and mixtures thereof.

Examples of suitable glycols include ethylene glycol, propylene glycol, butanediol, pentanediol, hexanediol, 1,4-cyclohexane-dimethanol, diethylene glycol, other polyethylene glycols and mixtures thereof. Such polyesters are well known in the art and many may be produced by well known techniques for example those described in U.S. Pat. Nos. 2,465,319 and 2,901,466. Preferred polymers for the matrix or continuous phase of the upper layer are those having repeat units from terephthalic acid or naphthalene dicarboxylic acid and at least one glycol selected from ethylene glycol, 1,4-butanediol, and 1,4-cyclohexanedimethanol. Poly(ethylene terephthalate), which can be modified by small amounts of other monomers, is especially preferred.

Voids in the ink-permeable upper polyester layer may be obtained by using microbeads acting as voiding agents when manufacturing the support. Such microbeads may be inorganic fillers or polymerizable organic materials. The microbead particle size is between 0.01 μm and 50.0 μm, preferably between 0.1 μm and 10 μm, preferably between 0.5 μm and 5 μm, for best formation of an ink porous but smooth surface. The voiding agent or the microbeads may be employed in an amount of 30 to 50 percent by volume in the feed stock for the ink-permeable upper polyester layer prior to extrusion and microvoiding. Typical inorganic materials for the microbeads include silica, alumina, calcium carbonate and barium sulfate. Typical polymeric organic materials for the microbeads include polystyrenes, polyamines, fluoropolymers, poly(methylmethacrylate), poly(butyl acrylate), polycarbonates, and polyolefins.

A preparation method of the support used in the present invention is described in Patent Application EP-A-1,112,858.

The microbeads of the upper layer are at least partially bordered by void spaces forming the interconnected or open-celled pores of said layer. The void spaces surrounding the microbeads are formed as the matrix or continuous polyester phase is stretched as explained in Patent Application EP-A-1,112,858.

The support has paper laminated on the other side of the base polyester layer opposite the upper polyester layer. In this case the base layer can be thin, the paper providing sufficient stiffness.

In another embodiment, the support can also comprise a lower permeable layer, adjacent to the base polyester layer on the opposite side from the ink-permeable upper polyester layer. The lower layer can be produced with the same compounds as the upper permeable layer described above.

The inkjet recording element according to the invention then comprises at least one ink-receiving layer. This ink-receiving layer is characterized in that it does not comprise a binder, which would reduce the porous support's absorbent capacity. Binders historically used in ink-receiving layers are hydrophilic polymers such as polyvinyl alcohol, poly(vinyl pyrrolidone), gelatin, cellulose ethers, poly(oxazolines), poly(vinylacetamides), poly(vinyl acetate/vinyl alcohol) partially hydrolyzed, poly(acrylic acid), poly(acrylamide), sulfonated or phosphated polyesters and polystyrenes, casein, zein, albumin, chitin, dextran, pectin, derivatives of collagen, agar-agar, guar, carrageenan, tragacanth, xanthan and others. The binder can also be a hydrophobic polymer, such as poly(styrene-co-butadiene), a polyurethane latex, a polyester latex, poly(n-butyl acrylate), poly(n-butyl methacrylate), poly(2-ethylhexyl acrylate), a copolymer of n-butyl acrylate and ethyl acrylate, a copolymer of vinyl acetate and n-butyl acrylate, etc.

According to the present invention, the ink-receiving layer comprises, as receiving agent, at least one hybrid aluminosilicate polymer obtainable by a preparation method comprising the following steps:
a) treating a mixed aluminum and silicon alkoxide of which the silicon has both hydrolyzable substituents and a non-hydrolyzable substituent, or a mixed aluminum and silicon precursor resulting from the hydrolysis of a mixture of aluminum compounds and silicon compounds only having hydrolyzable substituents and silicon compounds having a non-hydrolyzable substituent, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;
b) stirring the mixture resulting from step a) at ambient temperature in the presence of silanol groups long enough to form the hybrid aluminosilicate polymer; and
c) eliminating the byproducts formed during steps a) and b) from the reaction medium.

This hybrid aluminosilicate polymer is described in French Patent Application FR 02/9086.

According to one embodiment, the modified mixed aluminum and silicon precursor is formed in situ by mixing in aqueous medium (i) one compound selected from the group consisting of aluminum salts, aluminum alkoxides and aluminum halogenoalkoxides and (ii) at least one compound selected from the group consisting of unmodified silicon alkoxides and chloroalkoxides, and (iii) at least one compound selected from the group consisting of modified silicon alkoxides and chloroalkoxides.

The modified or unmodified alkoxide radical of the aluminum compound or silicon compound preferably contains 1 to 5 carbon atoms, such as methoxide, ethoxide, n-propoxide, or i-propoxide.

Preferably, an aluminum salt is used, such as a halide (e.g. chloride or bromide), a perhalogenate, a sulfate, a nitrate, a phosphate or a carboxylate. An aluminum halide, such as chloride, is particularly preferred.

Preferably, silicon compounds are used in the form of alkoxides.

A single unmodified silicon alkoxide or a mixture of unmodified silicon alkoxides, or a single unmodified silicon chloroalkoxide or a mixture of unmodified silicon chloroalkoxides, or a mixture of unmodified silicon alkoxides and chloroalkoxides can be used. Similarly, a single modified silicon alkoxide or a mixture of modified silicon alkoxides, or a single modified silicon chloroalkoxide or a mixture of modified silicon chloroalkoxides, or a mixture of modified silicon alkoxides and chloroalkoxides can be used.

Preferably, a mixture (i) of an aluminum halide and (ii) a mixture with at least one unmodified silicon alkoxide and at least one modified silicon alkoxide is produced.

An unmodified silicon alkoxide can be represented by the formula Si—(OR)₄, and a modified silicon alkoxide can be represented by the formula
R′—Si—(OR)₃,
wherein R represents an alkyl group comprising 1 to 5 carbon atoms

R′ represents H, F, or a substituted or unsubstituted linear or branched alkyl or alkenyl group, comprising 1 to 8 carbon atoms, e.g. a methyl, ethyl, n-propyl, n-butyl, 3-chloropropyl group, or a vinyl group.

Preferably, the unmodified silicon alkoxide is tetramethyl or tetraethyl orthosilicate, and the modified silicon alkoxide is methyltriethoxysilane or vinyltriethoxysilane.

The ratio of unmodified silicon alkoxide to modified silicon alkoxide is between 0.1 and 10 in moles of silicon, and is preferably about 1.

In practice, the unmodified silicon alkoxide and modified silicon alkoxide mixture is first produced pure or diluted in a co-solvent such as an alcohol. Said alcohol is preferably ethanol, used in sufficient amount to obtain a clear homogeneous mixture once the silicon compounds are mixed with the aluminum compound. Then, this mixture is added to the aluminum salt in aqueous solution, with stirring, at ambient temperature between 15° C. and 35° C., preferably between 20° C. and 25° C., until a clear homogeneous mixture is obtained. A modified mixed aluminum and silicon precursor is thus obtained. The stirring time varies from 10 to 240 minutes, and is preferably 120 minutes.

According to step a) of the method for preparing the hybrid aluminosilicate polymer useful in the invention, the precursor or a modified mixed aluminum and silicon alkoxide is then put in contact with an aqueous alkali, the aluminum concentration being maintained at less than 0.3 mol/l, the Al/Si molar ratio being maintained between 1 and 3.6, and the alkali/Al molar ratio being maintained between 2.3 and 3. Advantageously, the aluminum concentration is between 1.4×10⁻² and 0.3 mol/l and even more preferably between 4.3×10⁻² and 0.3 mol/l. Preferably, the Al/Si molar ratio is between 1 and 2.

Preferably, an aqueous solution of sodium, potassium, or lithium hydroxide, diethylamine or triethylamine with a concentration between 0.5 M and 3 M, and preferably 3 M is used. The alkali can also be in the form of an hydroalcoholic solution.

The alkali is added to the precursor or to the modified mixed aluminum and silicon alkoxide at a rate preferably between 50 and 650 mmoles/hour.

The alkali in step a) is added in the presence of silanol groups. These groups can be supplied by glass or silica (glass wool) particles or beads, which have superficial hydroxy groups. When the volume of liquid to be treated is large, it may be desirable to increase the quantity of beads. The diameter of the beads can be between 0.2 and 5 mm and preferably between 1 and 3 mm. To simplify the implementation of the method for preparing the hybrid aluminosilicate polymer used in the present invention, the preparation of the mixed aluminum and silicon precursor can also be performed in the presence of silanol groups, for example by circulating the mixture in a bed of glass beads.

After the addition of the alkali, step b) of the method for preparing the hybrid aluminosilicate polymer used in the present invention consists in stirring the mixture resulting from step a) at ambient temperature in the presence of silanol groups long enough to form the said hybrid aluminosilicate polymer.

Then, step c) of the method for preparing the hybrid aluminosilicate polymer useful in the present invention consists in eliminating from the reaction medium the byproducts formed during steps a) and b), such as the residual ions coming essentially from the alkali used in step a). The residual ions can be eliminated by washing, by successive sedimentation or by diafiltration. The hybrid aluminosilicate polymer resulting from step c) can then be concentrated by centrifugation or nanofiltration. The introduction of non-hydrolyzable substituents, such as organic functions, enables providing for example an organophilic character to the resulting hybrid aluminosilicate polymers.

In a first embodiment of the method for preparing the hybrid aluminosilicate polymer useful in the present invention, during step a) a quantity of alkali is added in order to obtain an alkali/Al molar ratio of about 2.3. In this case the pH is maintained between 4 and 5, and preferably between 4.2 and 4.3. Then step b) as described above is applied. The hybrid aluminosilicate polymer used in the present invention is thus obtained in dispersion form. Step c) to eliminate the residual ions can then be performed by diafiltration, followed by nanofiltration concentration.

In a second embodiment of the method for preparing the hybrid aluminosilicate polymer used in the present invention, during step a) a quantity of alkali is added in order to obtain an alkali/Al molar ratio of about 3. Then step b) as described above is applied. The hybrid aluminosilicate polymer useful in the present invention is thus obtained in suspension form. Step c) to eliminate the residual ions can then be performed by diafiltration, followed by nanofiltration concentration, the hybrid aluminosilicate polymer having been previously redispersed by adding acid, such as hydrochloric or acetic acid or a mixture thereof.

In a third embodiment, the method for preparing the hybrid aluminosilicate polymer useful in the present invention comprises an additional step d), after step b) and before step c). Said step d) consists in adding in a few minutes an additional quantity of aqueous alkali to reach an alkali/Al molar ratio of 3 if this ratio had not already been reached during step a). The hybrid aluminosilicate polymer useful in the present invention is thus obtained in suspension form. Step c) to eliminate the residual ions can then be performed by diafiltration, followed by nanofiltration concentration, the hybrid aluminosilicate polymer having been previously redispersed by adding hydrochloric acid. Step c) can also be performed by washing with osmosed water by successive sedimentations, followed by centrifugation concentration.

The hybrid aluminosilicate polymer useful in the present invention resulting from step c) followed by concentration has physical gel form. The Al/Si molar ratio is between 1 and 3.6. Subsequent lyophilization enables the hybrid aluminosilicate polymer useful in the present invention to be obtained in powder form. Such a hybrid aluminosilicate polymer can be characterized in that its Raman spectrum comprises in spectral region 200 cm^{31 1} to 600 cm⁻¹ a wide band at 250±6 cm⁻¹, a wide intense band at 359±6 cm⁻¹, a shoulder at 407±7 cm⁻¹, and a wide band at 501±6 cm⁻¹, as well as bands corresponding to the silicon non-hydrolyzable substituent, bands linked to the silicon non-hydrolyzable substituent can be juxtaposed with other bands. The Raman spectrum is produced for the resulting hybrid aluminosilicate polymer after step b) and before step c) and lyophilized.

The ink-receiving layer comprises at least 5 percent by weight of hybrid aluminosilicate polymer compared with the total weight of the dry state ink-receiving layer.

The composition intended to be applied to the support to constitute the ink-receiving layer of the inkjet recording element according to the invention is produced by diluting the aluminosilicate polymer used in the present invention in water to adjust its viscosity and facilitate its coating. The composition then has the form of an aqueous solution or a dispersion containing all the necessary components. When the hybrid aluminosilicate polymer as described above is used for preparing the composition as a powder, this powder must be very fine.

The composition can also comprise a surfactant to improve its coating properties. The composition can be applied on the support according to any appropriate coating method, such as air knife, blade, roller, curtain coating, or by dipping. The composition is applied with a thickness between approximately 4 μm and 200 μm in the wet state. It is possible to provide an antistatic or anti-winding layer on the back of the support coated with the ink-receiving layer.

The inkjet recording element according to the invention can comprise, besides the ink-receiving layer described above, other layers having another function, arranged above or below said ink-receiving layer. The ink-receiving layer as well as the other layers can comprise all the other additives known to those skilled in the art to improve the properties of the resulting image, such as UV ray absorbers, optical brightening agents, antioxidants, plasticizers, etc.

The ink-receiving layer useful in the present invention has a thickness generally between 0.5 μm and 50 μm in the dry state.

The inkjet recording element comprising a porous polyester support and such an ink-receiving layer has improved image quality and dye keeping properties in time while keeping instant dryness. It can be used for any type of inkjet printer as well as for all the inks developed for this technology. These inks are liquid compositions comprising a solvent, dyes or pigments, humectants, etc. The solvent can be water uniquely or a mixture of water with other water-miscible solvents, such as polyhydric alcohols. The dyes used are generally directly soluble in water or are acid type dyes.

The following examples illustrate the present invention without however limiting the scope.

1) Preparation of the Support

A support comprising three polyester layers (one impermeable base layer, one ink-permeable lower layer and one ink-permeable upper layer) is prepared in the following way:

The materials used are:

1) a poly(ethylene terephthalate) (PET) resin (Viscosity Index IV=0.70 dl/g) for the base layer
2) a compounded blend for the lower and upper layers consisting of 29% by weight of an amorphous polyester resin, PETG 6763® (IV=0.73 dl/g) (marketed by Eastman Chemical Company), 29% by weight of poly(ethylene terephthalate) (PET) resin (IV=0.70 dl/g), and 42% by weight of cross-linked PMMA particles having a size of 1.7 μm approximately.

The cross-linked PMMA particles were compounded with the PETG 6763® and PET resins through mixing in a counter-rotating twin-screw extruder attached to a pelletizing die. The extrudate was passed through a water bath and pelletized. The two resins for the three layers were dried at 65° C. and fed by two plasticating screw extruders into a co-extrusion die manifold to produce a three-layered melt stream that was rapidly quenched on a chill roll after issuing from the die. By regulating the throughputs of the extruders, it was possible to adjust the thickness ratio of the layers in the cast laminate sheet. In this case, the thickness ratio of the three layers was adjusted to 1:6:1, the thickness of the two outside layers being approximately 250 μm. The cast sheet was first oriented in the machine direction by stretching at a ratio of 3.3 and a temperature of 110° C.

The oriented support was then stretched in the transverse direction in a tenter frame at a ratio of 3.3 and a temperature of 100° C. In this example, no heat setting treatment was applied. The final total thickness of the film was 200 μm, the permeable lower and upper layers each having a thickness of 50 μm, and the layers within the support were fully integrated and strongly bonded. The stretching of the heterogeneous lower and upper layers created interconnected microvoids around the hard cross-linked PMMA beads, thus rendering these layers opaque (white), highly porous and permeable. The base PET layer was impermeable and retained its natural clarity.

2) Preparation of Various Aluminosilicates

Synthesis No. 1

15.46 moles AlCl₃, 6H₂O were added to 751 osmosed water. 3.5 kg of 2-mm glass beads were added. Separately, a mixture of tetraethyl orthosilicate and methyltriethoxysilane was prepared in a quantity corresponding to 4,29 moles silicon and so as to have a ratio of tetraethyl orthosilicate to methyltriethoxysilane of 1 in moles silicon. This mixture was added to the aluminum chloride solution. The resulting mixture was stirred. The operation of preparing the modified mixed aluminum and silicon precursor took 20 minutes. Then, according to step a) of the method for preparing the hybrid aluminosilicate polymer, 46.39 moles NaOH 0.6M were added in 30 minutes. Aluminum concentration was 0.1 mo/l, Al/Si molar ratio 3,6 and alkali/Al ratio 3. The reaction medium clouded. According to step b) of the preparation method, the mixture was stirred for 15 minutes. The hybrid aluminosilicate polymer was obtained in suspension form. Step c) of the preparation method consisted in adding 690.3 g of HCl 37% by weight, and stirring for 30 minutes to obtain a clear medium. The hybrid aluminosilicate polymer used in the present invention was thus obtained in dispersion form. Preconcentration by a factor of 3 was then performed by nanofiltration, then diafiltration using a Filmtec NF 2540 nanofiltration membrane (surface area 6 m²) to eliminate the sodium salts to obtain an Al/Na rate greater than 100. The retentate resulting from the diafiltration by nanofiltration was concentrated to obtain a gel with about 21% by weight of hybrid aluminosilicate polymer used in the present invention.

Synthesis No. 2

4.53 moles AlCl₃, 6H₂O were added to 1001 osmosed water. Separately, a mixture of tetraethyl orthosilicate and methyltriethoxysilane was prepared in a quantity corresponding to 2,52 moles silicon and so as to have a ratio of tetraethyl orthosilicate to methyltriethoxysilane of 1 in moles silicon. This mixture was added to the aluminum chloride solution. The resulting mixture was stirred and circulated simultaneously through a bed formed of 1 kg glass beads 2-mm diameter using a pump with output of 81/min. The operation of preparing the modified mixed aluminum and silicon precursor took 120 minutes. Then, according to step a) of the method for preparing the hybrid aluminosilicate polymer, 10.5 moles NaOH 3M were added in four hours. Aluminum concentration was 4.3×10⁻² mol/l, Al/Si molar ratio 1.8 and alkali/Al ratio 2.31. The reaction medium clouded. According to step b) of the preparation method, the mixture was stirred for 48 hours. The medium became clear. The circulation was stopped in the glass bead bed. The hybrid aluminosilicate polymer used in the present invention was thus obtained in dispersion form. Step c) of the preparation method consisted in performing preconcentration by a factor of 3 by nanofiltration, then diafiltration using a Filmtec NF 2540 nanofiltration membrane (surface area 6 m²) to eliminate the sodium salts to obtain an Al/Na rate greater than 100. The retentate resulting from the diafiltration by nanofiltration was concentrated to obtain a gel with about 19.3% by weight of hybrid aluminosilicate polymer used in the present invention.

3) Examples of Inkjet Recording Elements for Inkjet Printing with Dye-Based Inks

a) Preparation of Compositions Intended to be Applied on the Support to Constitute an Ink-Receiving Layer by Coating

Aluminosilicate polymer prepared according to Synthesis No. 1 was used as receiving agent and Glycidol 10G (CAS 68072-38-8) diluted 10% by weight marketed by Arch Chemical Inc as surfactant.

The composition was obtained by mixing:

15.8 g water
4 g receiving agent (at 21%)
0.2 g Glycidol surfactant 10G
   When the receiving agent has powder form, the particles must first be crushed finely.
   b) Preparation of Inkjet Recording Elements for Forming Images by Inkjet Printing by Coating

For this, the support obtained in paragraph 1 was placed on a coating machine and held on the coating machine by vacuum. This support was coated with a composition as prepared according to paragraph 3a) using a 25 μm thick filmograph. Then, it is left to dry overnight at ambient air temperature (21° C.).

The resulting inkjet recording element corresponded to example 1.

Comparative example 2 corresponds to the porous polyester support alone.

c) Preparation of Compositions Intended to be Applied on the Support to Constitute an Ink-Receiving Layer by Dipping

Aluminosilicate polymer prepared according to Synthesis No. 1 was used as receiving agent and Glycidol 10G as surfactant.

The composition was obtained by mixing:

receiving agent (at 21%): 50 parts
Glycidol surfactant 1OG: 0.1 parts
water: 49.9 parts
   d) Preparation of an Inkjet Recording Element by Dipping

For this, a strip of the support obtained in Paragraph 1 with dimensions 8×4 cm was used and was dipped for 10 seconds in the composition as prepared according to paragraph 3c). Then the strip was dried at room temperature overnight (21° C.).

The inkjet recording element according to the invention thus obtained corresponded to Example 3.

e) Evaluation of Dye Keeping Properties in Time

To evaluate the dye keeping properties in time, a dye fading test by exposure to ozone was performed for each resulting inkjet recording element. To do this, targets, comprising four colors (black, yellow, cyan and magenta) were printed on each inkjet recording element using a KODAK PPM 200 printer and related ink. The targets were analyzed using a GretagMacbeth™ Spectrolino spectrophotometer that measured the intensity of the various colors. Then the inkjet recording elements were placed in the dark in a room with controlled ozone atmosphere (60 ppb) for three weeks. Each week, any degradation of the color density was monitored using the spectrophotometer.

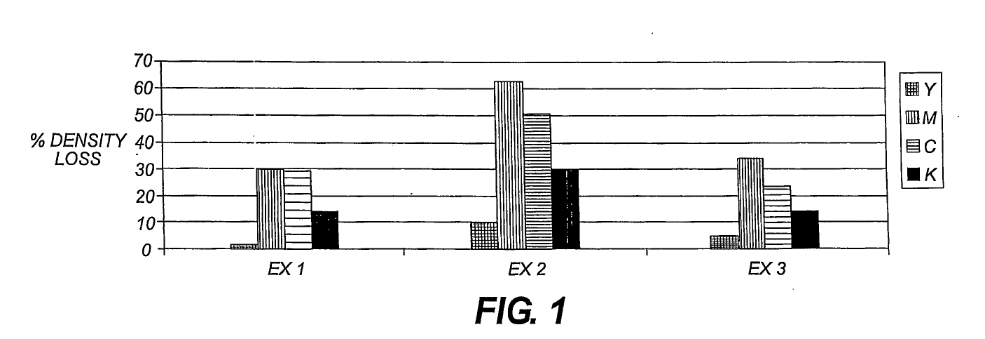

FIG. 1 represents the percentage of density loss observed for the original density for the four colors of the target after three weeks for examples 1 to 3. Letters K, C, M and Y represent the colors black, cyan, magenta and yellow respectively.

It may be seen that the inkjet recording elements according to the invention (Ex. 1 and 3) have dye keeping in time superior to that observed for the porous polyester support alone (Ex. 5).

f) Instant Dryness Measurement

To evaluate the instant dryness, a PISA apparatus was used as described in the article Spreading and Inhibition of Liquid Droplets on Porous Surfaces, Langmuir 2002, 18, 2980-2984, A. Clarke, T. D. 13lake, K. Carruthers, A. Woodward. This apparatus enables the behavior of liquid droplets on a porous surface to be studied by measuring the volume of the droplet at the surface of the porous material as a function of time.

The composition of the liquid used to form the droplets is near that of an ink not comprising dyes.

An example of liquid composition to form droplets is given in Table I below:

TABLE I

| Ingredient | % by weight in H₂O |
|---|---|
| Glycerol | 12.3 |
| DEG | 10.8 |
| PEGMBE | 10.7 |
| TEA | 0.6 |
| pH | 8.8 |

DEG: diethylene glycol
PEGMBE = Poly(EthyleneGlycol) Monobutyl Ether
TEA = Triethanolamine

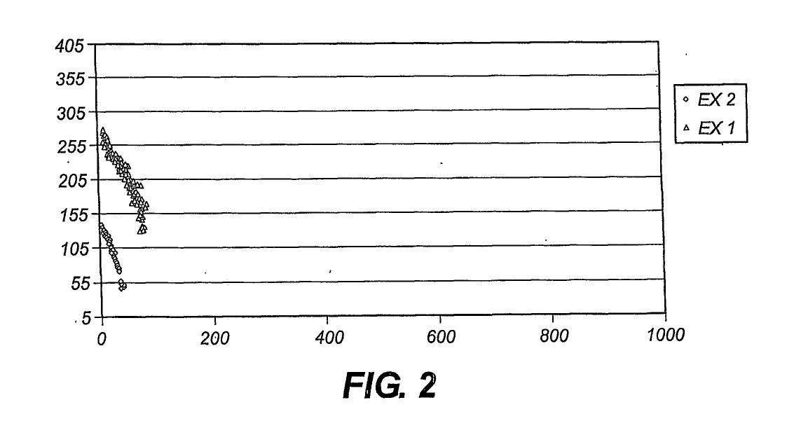

FIG. 2 represents as a function of time the volume of a droplet of the liquid composition described in Table I applied to an inkjet recording element corresponding to Examples 1 and 2.

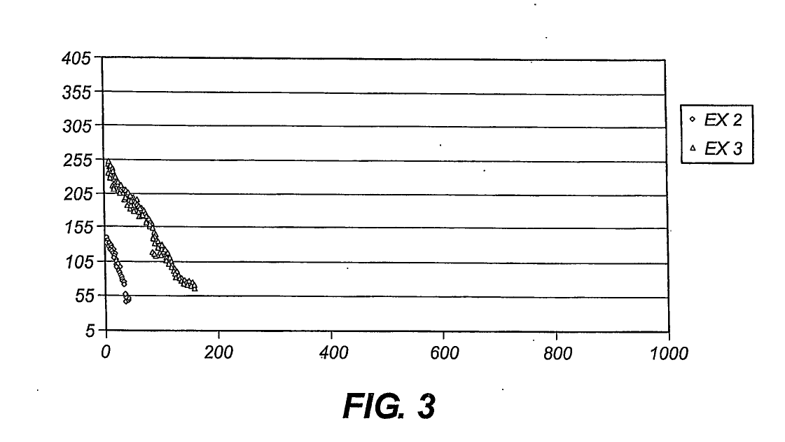

FIG. 3 represents as a function of time the volume of a droplet of the liquid composition described in Table I applied to an inkjet recording element corresponding to Examples 2 and 3.

It may be noted that the inkjet recording elements according to the invention (Examples 1 and 3) have droplet volume growth as a function of time similar to the porous polyester support not comprising receiving agent in the ink-receiving layer (Example 2). The inkjet recording element according to the invention thus has the same dry time as a porous polyester support and also has good dye keeping, contrary to a porous polyester support.

4) Examples of Inkjet Recording Elements for Inkjet Printing with Pigment-Based Inks

a) Preparation of Compositions Intended to be Applied on the Support to Constitute an Ink-Receiving Layer by Coating

Aluminosilicate polymer prepared according to Synthesis No. 2 was used as receiving agent and Glycidol 10G as surfactant.

The composition was obtained by mixing:

Aluminosilicate polymer, Synthesis No. 2 (19.3%): 518 g
Glycidol surfactant 10G: 10 g
Water: 472 g
   The various components were mixed together with stirring for 24 hours.
   b) Preparation of Inkjet Recording Elements for Forming Images by Inkjet Printing by Coating

For this, the support obtained in paragraph 1 was placed on a coating machine and held on the coating machine by vacuum. This support was coated with a composition as prepared according to paragraph 4a) so as to obtain a dry thickness of 2 μm approximately. Then, it was left to dry for 24 hours at room temperature (21° C.).

The resulting inkjet recording element corresponded to example 4.

c) Preparation of Compositions Intended to be Applied on the Support to constitute an Ink-Receiving Layer by Dipping

The composition as prepared in paragraph 4a) was used.

d) Preparation of an Inkjet Recording Element by Dipping

For this, a strip of the support obtained in paragraph 1 with dimensions 22×28 cm was used and was dipped for 1 minute in the composition as prepared according to paragraph 4a). Then the strip was dried at room temperature for 24 hours (21° C.).

The inkjet recording element according to the invention thus obtained corresponded to Example 5.

The porous polyester support alone corresponds to Example 6.

e) Evaluation of the Density

The porous polyester support used in the present invention has many advantages for inkjet printing, especially a high capacity for absorbing inks, resistance to cockle and excellent durability. However, due to the relatively large pore size (greater than 1 μm), the inks can penetrate deeply into the support resulting in a loss of printed density. As pigment-based inks offer improved light stability over dye-based inks, it is important to obtain an inkjet recording element for pigment-based inkjet printing that offers good densities and a good image quality.

To measure the-printed-density, on each inkjet recording element corresponding to examples 4, 5 and 6, targets composed of four colors, black, yellow, cyan and magenta were printed using a wide format printer Mutoh Falcon (Kodak 3038) and Epson 9500 pigment-based inks, with cartridges Black T474, Yellow T475, Magenta T476 and Cyan T477 (100%). The targets comprise the colors cyan, magenta, yellow and black 100%.

The targets were analyzed using a X-Rite Densitometer Model 820. The results are given below in Table II.

TABLE II

| Inkjet | | | |
|---|---|---|---|
| recording | | | Yellow |
| element | Cyan density | Magenta density | density |
| Ex. 4 (inv.) | 1.15 | 1.25 | 0.99 |
| Ex. 5 (inv.) | 1.05 | 1.17 | 0.97 |
| Ex. 6 (comp.) | 0.83 | 0.77 | 0.76 |

The results of Table II show that the inkjet recording elements according to the present invention enable higher densities to be obtained than the porous polyester support alone. The ink-receiving layer comprising the aluminosilicate polymer used in the present invention enables pigments to be retained at the inkjet recording element surface and prevents their penetration into the porous polyester support. The inkjet recording elements according to the invention thus enable a better image quality to be obtained by pigment-based inkjet printing.

1. An inkjet recording element, comprising a support and at least one ink-receiving layer, wherein
said support comprises a base polyester layer and a porous ink-permeable upper polyester layer, said upper polyester layer comprising a continuous polyester phase having an ink absorbency rate resulting in a dry time of less than 10 seconds and a total absorbent capacity of at least 14 cm³/m², said ink-receiving layer comprises at least one hybrid aluminosilicate polymer obtainable by a preparation method comprising the following steps:
a) treating a mixed aluminum and silicon alkoxide of which the silicon has both hydrolyzable substituents and a non-hydrolyzable substituent, or a mixed aluminum and silicon precursor resulting from the hydrolysis of a mixture of aluminum compounds and silicon compounds only having hydrolyzable substituents and silicon compounds having a non-hydrolyzable substituent, with an aqueous alkali, in the presence of silanol groups, the aluminum concentration being maintained at less than 0.3 mol/l, the Al/Si molar ratio being maintained between 1 and 3.6 and the alkali/Al molar ratio being maintained between 2.3 and 3;
b) stirring the mixture resulting from step a) at ambient temperature in the presence of silanol groups long enough to form the hybrid aluminosilicate polymer; and
c) eliminating the byproducts formed during steps a) and b) from the reaction medium,
and said ink-receiving layer does not contain a binder.

2. The recording element according to claim 1, wherein the alkali of step a) to prepare the hybrid aluminosilicate polymer is selected from the group consisting of sodium, potassium, or lithium hydroxide, diethylamine and triethylamine.

3. The recording element according to claim 1, wherein the aluminum concentration used to prepare the hybrid aluminosilicate polymer is maintained between 1.4×10⁻² and 0.3 mol/l.

4. The recording element according to claim 1, wherein the aluminum concentration used to prepare the hybrid aluminosilicate polymer is maintained between 4.3×10⁻² and 0.3 mol/l.

5. The recording element according to claim 1, wherein said alkali/Al molar ratio to prepare the hybrid aluminosilicate polymer is about 2.3.

6. The recording element according to claim 1, wherein said alkali/Al molar ratio to prepare the hybrid aluminosilicate polymer is about 3.

7. The element according to claim 1, wherein the method for preparing the hybrid aluminosilicate polymer comprises, after step b) and before step c), a step d), by which alkali is added in order to reach an alkali/Al molar ratio of 3 if this ratio has not already been reached in step a).

8. The recording element according to claim 1, wherein said mixed aluminum and silicon precursor resulting from hydrolysis of a mixture of aluminum compounds and silicon compounds only having hydrolyzable substituents and silicon compounds having a non-hydrolyzable substituent is a product resulting from the mixture in an aqueous medium (i) of a compound selected from the group consisting of aluminum salts, aluminum alkoxides and aluminum halogenoalkoxides and (ii) at least one compound selected from the group consisting of silicon alkoxides and chloroalkoxides only having hydrolyzable substituents, and (iii) at least one compound selected from the group consisting of silicon alkoxides and chloroalkoxides having a non-hydrolyzable substituent.

9. The recording element according to claim 8, wherein said mixed aluminum and silicon precursor is the product resulting from the mixture (i) of an aluminum halide and (ii) a mixture having at least one silicon alkoxide only having hydrolyzable substituents and at least one silicon alkoxide having a non-hydrolyzable substituent.

10. The recording element according to claim 9, wherein the ratio of silicon alkoxide only having hydrolyzable substituents to silicon alkoxide having a non-hydrolyzable substituent is between 0.1 and 10 in moles silicon.

11. The recording element according to claim 10, wherein the ratio of silicon alkoxide only having hydrolyzable substituents to silicon alkoxide having a non-hydrolyzable substituent is 1 in moles silicon.

12. The recording element according to any one of claims 8 to 11, wherein the silicon alkoxide having a non-hydrolyzable substituent is represented by the formula
R′—Si—(OR)₃
wherein R represents an alkyl group comprising 1 to 5 carbon atoms R′ represents H, F, or a substituted or unsubstituted linear or branched alkyl or alkenyl group comprising 1 to 8 carbon atoms.

13. The recording element according to claim 12, wherein R′ represents a methyl, ethyl, n-propyl, n-butyl, 3-chloropropyl, or vinyl group.

14. The recording element according to claim 13, wherein said silicon alkoxide having a non-hydrolyzable substituent is methyltriethoxysilane or vinyltriethoxysilane.

15. The recording element according to claim 9, wherein said silicon alkoxide only having hydrolyzable substituents is tetramethyl orthosilicate or tetraethyl orthosilicate.

16. The recording element according to claim 1, wherein said ink-receiving layer comprises at least 5 percent by weight of aluminosilicate polymer compared with the total weight of the dry receiving layer.

17. The recording element according to claim 1, wherein said based polyester layer comprises poly(ethylene terephthalate).

18. The recording element according to claim 1, wherein said continuous phase of polyester of said upper polyester top layer comprises poly(ethylene terephthalate), poly(ethylene-1,4-cyclohexylenedimethylene terephthalate), or mixtures thereof.

19. The recording element according to claim 1, wherein said porous upper polyester layer comprises at least one voiding agent present in an amount of from 30% to 50% by volume of said upper layer.

20. The recording element according to claim 19, wherein said voiding agent is selected from the group consisting in fluoropolymers, silica, alumina, barium sulfate, calcium carbonate, polystyrene, poly(methyl methacrylate), polycarbonates, and polyolefines.

21. The recording element according to claim 19, wherein said voiding agent is between 0.1 μm and 10.0 μm in size.

22. The recording element according to claim 19, wherein said ink-permeable upper polyester layer has interconnecting voids.
